(19) United States
(12) Patent Application Publication
(10) Pub. No.: US 2015/0277825 A1
(43) Pub. Date: Oct. 1, 2015

(54) INFORMATION PROCESSING APPARATUS AND METHOD

(71) Applicant: CANON KABUSHIKI KAISHA, Tokyo (JP)

(72) Inventor: Naohiro Isobe, Kawasaki-shi (JP)

(21) Appl. No.: 14/675,388

(22) Filed: Mar. 31, 2015

(30) Foreign Application Priority Data
Apr. 1, 2014 (JP) 2014-075826

(51) Int. Cl. G06F 3/12

(52) U.S. Cl. CPC G06F 3/1243; G06F 3/122

(57) ABSTRACT

An information processing apparatus including a first generation unit configured to generate a data source object based on data source information, a first description unit configured to describe, in variable print data in variable-data printing, reference information for referencing the data source object generated by the first generation unit, a second generation unit configured to generate, based on placeholder information, a placeholder object related to generation of a print object based on the data source object to be referenced by the reference information described by the first description unit, and a second description unit configured to describe, in a page object of the variable print data, reference information for referencing the placeholder object generated by the second generation unit.

### BACKGROUND OF THE INVENTION

1. Field of the Invention

The present invention relates to a printing technique known as variable-data printing.

2. Description of the Related Art

Conventionally, there is a printing technique known as variable-data printing (VDP). A document used in VDP is divided into a fixed portion and a variable portion, and data of the variable portion is supplied from a data source, such as a relational database (RDB) or a comma-separated values (CSV) file. In VDP, a column of a data source is associated with a variable portion of a template document and applied to each line (record) of the data source, thereby different contents are printed. A set of pieces of logical information, such as a page layout and a data source required for a single operation of VDP is referred to as a “VDP document”. Physical electronic data into which a VDP document has been converted is referred to as “VDP data”.

Generally, VDP data may use any page description language (hereinafter referred to as “PDL”), but often uses a PDL dedicated to VDP. This is because the PDL dedicated to VDP enables defining an object in a fixed portion of a VDP document (hereinafter referred to as a “fixed object”) in advance and describing reference information referencing the fixed object later. When the process of printing such a PDL is performed, it is only necessary to hold in advance the result of the process of interpreting an individual fixed object and copy the result of the interpretation process every time the individual fixed object is referenced. Thus, it is possible to expect that the processing of the entirety of VDP data speeds up. That is, the PDL dedicated to VDP can represent a VDP document with high processing efficiency for an application for performing the process of analyzing VDP data.

The publication of Japanese Patent Application Laid-Open No. 2013-134748 discusses a technique for efficiently performing variable-data printing. More specifically, the publication of Japanese Patent Application Laid-Open No. 2013-134748 discusses a technique for having page information for only one record and providing each page with a placeholder that dynamically changes depending on the content of record data, thereby the amount of data is reduced to that of only one record.

A format discussed in the conventional art, however, does not have a data source, and therefore does not achieve a complete page description language. That is, variable-data printing cannot be performed using data in this format alone, and a user needs to separately provide a data source. On the other hand, in the case of a format having a data source, in a case where the data source has a large number of records, the amount of print data increases.

### SUMMARY OF THE INVENTION

The present invention is directed to reducing the amount of print data even with a large number of records in variable-data printing.

According to an aspect of the present invention, an information processing apparatus includes a first generation unit configured to generate a data source object based on data source information, a first description unit configured to describe, in variable print data in variable-data printing, reference information for referencing the data source object generated by the first generation unit, a second generation unit configured to generate, based on placeholder information, a placeholder object related to generation of a print object based on the data source object to be referenced by the reference information described by the first description unit, and a second description unit configured to describe, in a page object of the variable print data, reference information for referencing the placeholder object generated by the second generation unit, wherein the first generation unit generates the data source object inside the variable print data.

Further features of the present invention will become apparent from the following description of exemplary embodiments with reference to the attached drawings.

### BRIEF DESCRIPTION OF THE DRAWINGS

FIGS. 1A, 1B, 1C and 1D are diagrams illustrating an example of information included in extension Portable Document Format/Variable and transactional printing (PDF/VT).

FIG. 2 is a diagram illustrating an example of results of drawing pages for the number of records.

FIGS. 3A and 3B are diagrams each illustrating an example of a structure of extension PDF/VT.

FIG. 4 is a diagram illustrating an example of scripts of data source internal holding type extension PDF/VT.

FIGS. 5A and 5B are diagrams each illustrating an example of scripts of data source external reference type extension PDF/VT.

FIG. 6 is a diagram illustrating an example of a system configuration.

FIG. 7 is a diagram illustrating an example of a hardware configuration.

FIG. 8 is a diagram illustrating an example of an outline of processing of an application according to a first exemplary embodiment.

FIG. 9 is a diagram illustrating an example of relationship between input data and output data according to the first exemplary embodiment.

FIG. 10 is a flow chart illustrating an example of processing according to the first exemplary embodiment.

FIGS. 11A and 11B are diagrams each illustrating an example of user interface.

FIG. 12 is a diagram illustrating an example of a placeholder information file.

FIGS. 13A and 13B are flow charts each illustrating an example of processing according to the first exemplary embodiment.

FIG. 14 is a diagram illustrating an example of an outline of processing of an application according to a second exemplary embodiment.

FIG. 15 is a diagram illustrating an example of relationship between input data and output data according to the second exemplary embodiment.

FIG. 16 is a flow chart illustrating an example of processing according to the second exemplary embodiment.

FIGS. 17A and 17B are diagrams each illustrating an example of user interface.

FIGS. 18A and 18B are flow charts each illustrating an example of processing according to the second exemplary embodiment.

### DESCRIPTION OF THE EMBODIMENTS

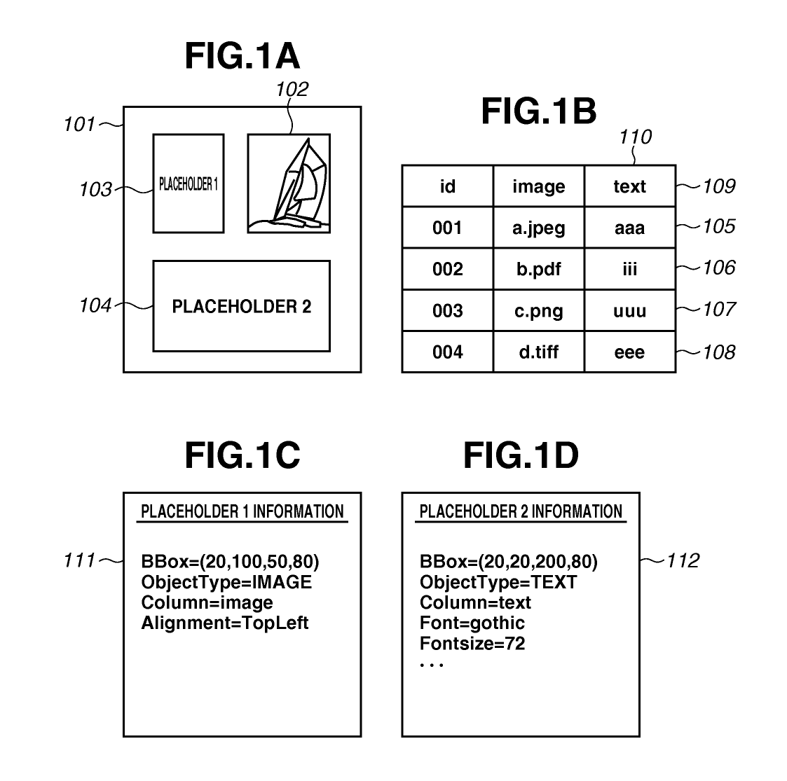

Exemplary embodiments for implementing the present invention will be described below with reference to the drawings. In the following description, variable-data printing, in which printing is performed by replacing a part of a print content, is referred to as “VDP”. Further, a set of pieces of logical information, such as a page layout and a data source, required for a single operation of VDP is referred to as a “VDP document”. Physical electronic data into which a VDP document has been converted is referred to as “VDP data (variable print data)”. Further, the following description is given using as a VDP data format a form in which a placeholder and data source information are added to Portable Document Format/Variable and transactional printing (PDF/VT) data, which will be described below with reference to FIGS. 1A, 1B, 1C and 1D and the like. Hereinafter, this format is referred to as “extension PDF/VT”.

### (Contents of Extension PDF/VT)

FIGS. 1A, 1B, 1C and 1D are diagrams illustrating an example of the concept of information included in extension PDF/VT according to an exemplary embodiment.

The extension PDF/VT has a page for one record illustrated in FIG. 1A, a data source illustrated in FIG. 1B, and pieces of placeholder information, illustrated in FIGS. 1C and 1D, of placeholders arranged on the page. Although the page for one record illustrated in FIG. 1A may be one or more pages, FIG. 1A illustrates only one page as an example.

On a page 101, a drawing object 102, such as an image or graphic can be arranged, and areas 103 and 104 termed placeholders 1 and 2, respectively can also be arranged, as on a page of normal PDF/VT. Each of the placeholders 1 and 2 represents an area where a drawing content drawn in the area dynamically changes according to the content of record information supplied from the data source.

A data source 110 illustrated in FIG. 1B has pieces of data for records to be handled in this variable print job.

FIGS. 1C and 1D illustrate pieces of placeholder information corresponding to the placeholders 1 and 2, respectively. Placeholder information has information for generating a drawing object to be drawn in a corresponding placeholder from record information of the data source. For example, the placeholder information illustrated in FIG. 1C indicates that the drawing area (BBox) has a size (BBox=(20,100,50,80)) from the position of coordinates (20, 100) to the position of coordinates (50, 80). Further, the placeholder information indicates that the type of the drawing object (ObjectType) is an “image” (ObjectType=IMAGE). Further, the placeholder information indicates that the file name of the image can be obtained from an “image” column of the data source (Column=image). Further, the placeholder information indicates that the drawing position in the drawing area (Alignment) is set based on the top left corner (Alignment=TopLeft). Placeholder information is not limited to that illustrated in this example. Further, in the following description, the replacement of a placeholder with a drawing object (a print object) based on placeholder information and record information is referred to as “instantiation”.

### (Results of Instantiating Extension PDF/VT)

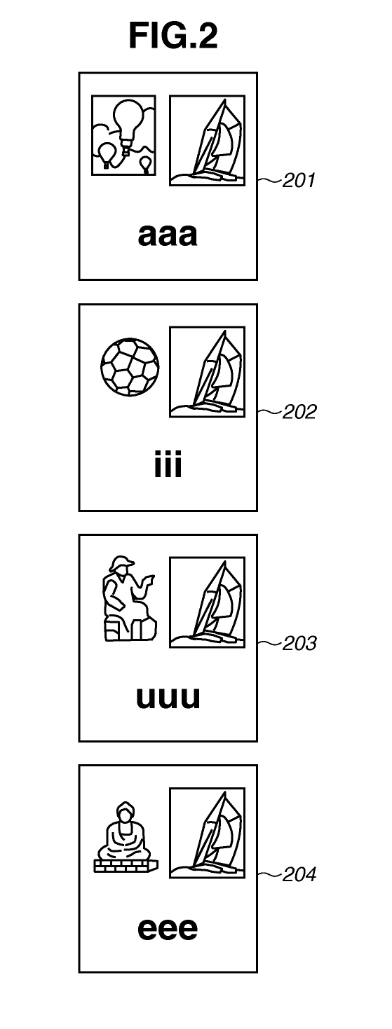

FIG. 2 is a diagram illustrating an example of results of drawing pages for the number of records when the extension PDF/VT in FIGS. 1A to 1D has been instantiated.

The data source 110 illustrated in FIG. 1B of the extension PDF/VT in FIGS. 1A to 1D includes four records (105, 106, 107, and 108). The extension PDF/VT in FIGS. 1A to 1D is instantiated as follows.

In the record 105 with id=001, an image described in a file having the name “a.jpeg” is drawn in the placeholder 1 (the area 103), and the text “aaa” is drawn in the placeholder 2 (the area 104), thereby a page 201 is generated. In the record 106 with id=002, an image described in a file having the name “b.pdf” is drawn in the placeholder 1 (the area 103), and the text “iii” is drawn in the placeholder 2 (the area 104), thereby a page 202 is generated. In the record 107 with id=003, an image described in a file having the name “c.png” is drawn in the placeholder 1 (the area 103), and the text “uuu” is drawn in the placeholder 2 (the area 104), thereby a page 203 is generated. In the record 108 with id=004, an image described in a file having the name “d.tiff” is drawn in the placeholder 1 (the area 103), and the text “eee” is drawn in the placeholder 2 (the area 104), thereby a page 204 is generated.

A group of pages for one record included in the extension PDF/VT serves as a pattern of instantiation. Thus, in the following description, a group of pages for one record included in the extension PDF/VT is referred to as a “template”.

### (Internal Structure of Extension PDF/VT)

Not only in the extension PDF/VT according to the present exemplary embodiment but also in PDF, the entirety of a document is represented in such a manner that a set of pieces of information having a certain meaning is represented as an “object”, and an object references another object. The extension PDF/VT according to the present exemplary embodiment is characterized by adding a new object and a new reference between objects to the structure of conventional PDF/VT, whereby a placeholder is included in a data source and a page as illustrated in FIGS. 1A to 1D.

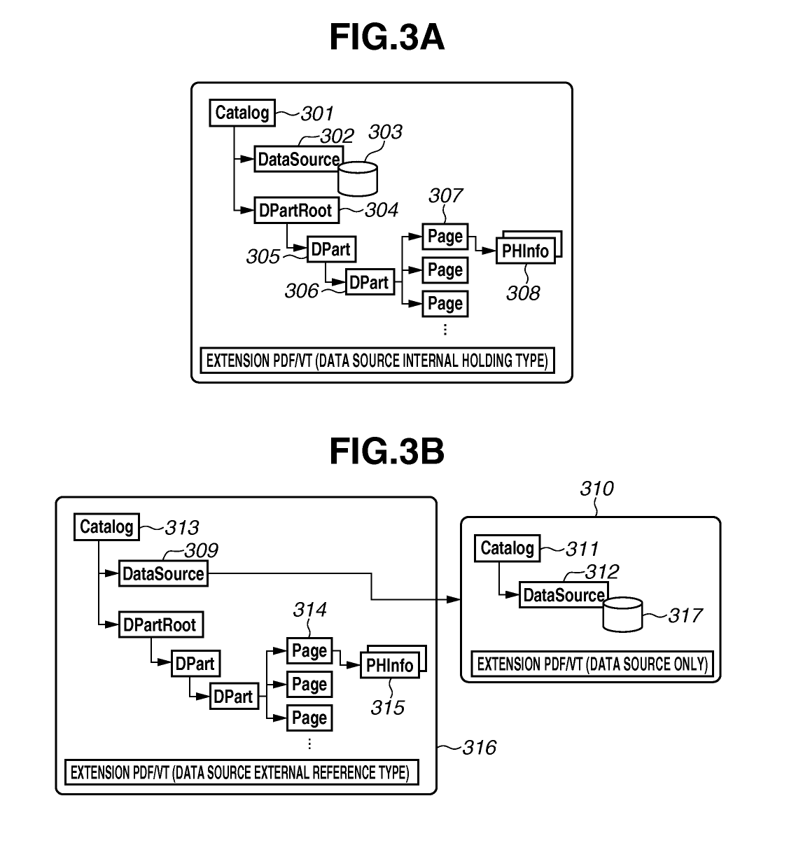

With reference to FIGS. 3A and 3B, the structure of the extension PDF/VT is described. FIGS. 3A and 3B are schematic diagrams each illustrating an example of objects inside the extension PDF/VT and the reference structure of the objects. The extension PDF/VT has two types, including a “data source internal holding type” illustrated in FIG. 3A and a “data source external reference type” illustrated in FIG. 3B.

### (Internal Structure of Data Source Internal Holding Type Extension PDF/VT)

The “data source internal holding type” illustrated in FIG. 3A is described.

The uppermost object in the object reference structure is a Catalog object 301. The Catalog object 301 references a DataSource object 302.

The DataSource object 302 is an object unique to the extension PDF/VT and holds information about a data source used in the extension PDF/VT. In the case of the “data source internal holding type”, the DataSource object 302 has substance 303 of a data source as illustrated in FIG. 1B.

The Catalog object 301 further references a DPartRoot object 304. The DPartRoot object 304 and DPart objects 305 and 306 are objects for structuring Page objects (page objects) described below. The specifications of this structure in PDF/VT are known, and therefore are not described in detail. The specifications of this structure in the extension PDF/VT according to the present exemplary embodiment are described here. The DPartRoot object 304 can have a DPart hierarchy under the DPartRoot object 304 and can have attribute information “RecordLevel”, which indicates which hierarchical level represents the record level. There is no limit on the number of hierarchical levels in the DPart hierarchy. In the extension PDF/VT, the value of the attribute “RecordLevel” is fixed to “1”, and the DPart object 305 to be referenced by the DPartRoot object 304 is restricted to referencing only the DPart object 306. Consequently, the extension PDF/VT has only Page objects for one record.

At the ends of the hierarchical structure including the DPartRoot object 304 and the DPart objects 305 and 306, Page objects 307 exist. Each of the Page objects 307 can have a drawing object as in conventional PDF and can also have a plurality of PHInfo objects 308.

The PHInfo objects 308 are objects for storing pieces of placeholder information on a page as illustrated in FIGS. 1C and 1D.

### (Examples of Scripts of Data Source Internal Holding Type Extension PDF/VT)

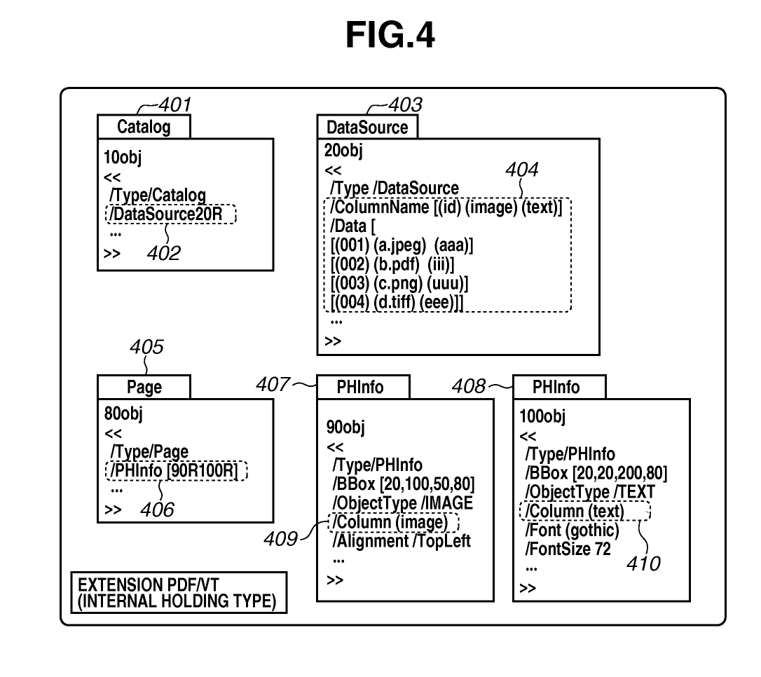

FIG. 4 is a diagram illustrating examples of scripts of the “data source internal holding type” extension PDF/VT illustrated in FIG. 3A. More specifically, FIG. 4 illustrates an example of the descriptions of the Catalog object 301, the DataSource object 302, the Page objects 307, and the PHInfo objects 308.

A Catalog object 401 references a DataSource object 403 in reference information 402, which is indicated by a “/DataSource20R” portion. The DataSource object 403 represents the substance of data in a portion starting with “/ColumnName” (a description 404).

A Page object 405 references PHInfo objects 407 and 408 in reference information 406, which is indicated by a “/PHInfo [90R100R]” portion.

The PHInfo objects 407 and 408 have pieces of placeholder information of corresponding placeholders. A “/Column(image)” portion (a description 409) and a “/Column(text)” portion (a description 410) in the PHInfo objects 407 and 408 indicate which column of the substance of the data (the description 404) in the DataSource object 403 is referenced.

The above examples are examples of the scripts for representing the structure of the data source internal holding type extension PDF/VT. However, the names of objects, the reference methods, and the method for representing the substance of the data are not limited to these examples so long as the scripts follow the descriptive grammar of PDF.

### (Internal Structure of Data Source External Reference Type Extension PDF/VT)

The “data source external reference type” illustrated in FIG. 3B is described.

The “data source external reference type” extension PDF/VT is different from the “data source internal holding type” extension PDF/VT in the contents of a DataSource object 309. In the “data source external reference type”, the DataSource object 309 does not have the substance of a data source, and references external extension PDF/VT 310, which is different from the extension PDF/VT.

The external extension PDF/VT 310 has a Catalog object 311 and a DataSource object 312, which is referenced by the Catalog object 311. The DataSource object 312 has substance 317 of a data source. This results in separating a template portion of the extension PDF/VT and a substance portion of the data source into different files. Further, since there is a limitation that the external extension PDF/VT 310 has the substance of the data source, the external extension PDF/VT 310 does not further reference different external extension PDF/VT. This prevents the occurrence of inconvenience where one file endlessly continues to reference another.

In the following description, in the data source external reference type extension PDF/VT, a reference source side file 316 is referred to as a “main body side file” or simply as a “main body side”, and a reference destination file 310 is referred to as a “data side file” or simply as a “data side”.

### (Examples of Scripts of Data Source External Reference Type Extension PDF/VT)

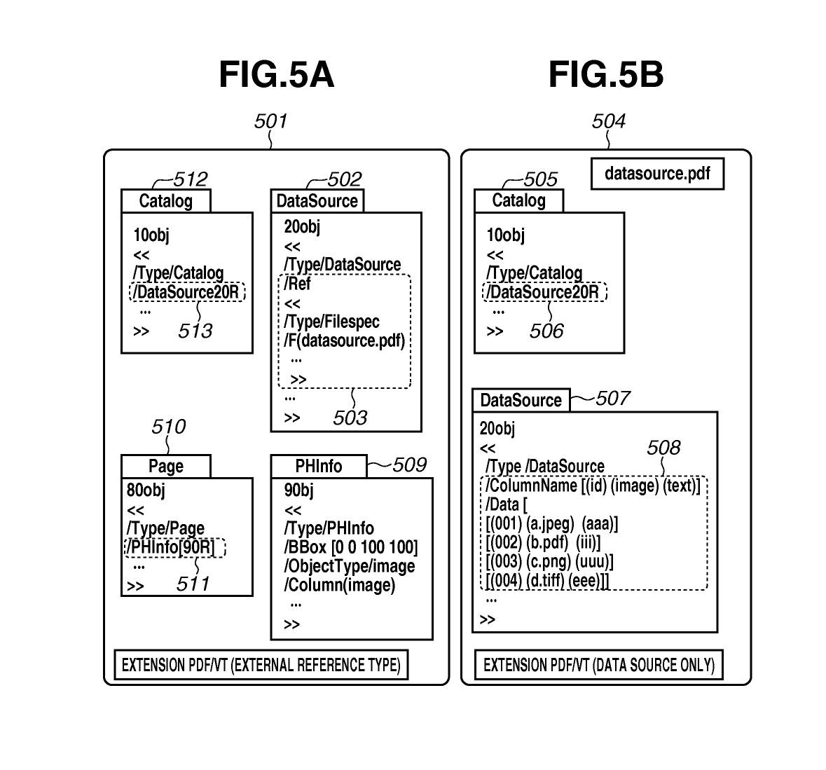

FIG. 5A is a diagram illustrating an example of the scripts of objects of the main body side file 316 in the “data source external reference type” extension PDF/VT illustrated in FIG. 3B. More specifically, FIG. 5A illustrates an example of the descriptions of a Catalog object 313, the DataSource object 309, Page objects 314, and PHInfo objects 315.

Further, FIG. 5B is a diagram illustrating an example of the scripts of objects of the data side file 310 in the “data source external reference type” extension PDF/VT illustrated in FIG. 3B. More specifically, FIG. 5B illustrates an example of the descriptions of the Catalog object 311 and the DataSource object 312.

A description is given below of only portions different from the examples of the descriptions of the scripts of the “data source internal holding type” extension PDF/VT illustrated in FIG. 4.

A DataSource object 502 of a main body side file 501 represents a reference to a data side file 504 in reference information 503, which is indicated by a portion starting with “/Ref”. This reference method uses the mechanism of the “reference XObject” included in the specifications of PDF.

A Catalog object 505 of the data side file 504 references a DataSource object 507 in reference information 506, which is indicated by a “/DataSource20R” portion.

The DataSource object 507 of the data side file 504 represents the substance of data in a portion starting with “/ColumnName” (a description 508).

The above examples are examples of the scripts for representing the structure of the data source external reference type extension PDF/VT. However, the names of objects, the reference methods, and the method for representing the substance of the data are not limited to these examples so long as the scripts follow the descriptive grammar of PDF.

### (Difference in Advantage Between Types of Extension PDF/VT)

In the data source internal holding type extension PDF/VT, the template and the substance of the data source are included in a single file. Thus, the data source internal holding type extension PDF/VT has the advantage of facilitating the management of a file. The data source external reference type extension PDF/VT has the advantage of replacing only a data side file without a user editing a main body side file, thereby obtaining another print result. This is effective when the user wishes to perform printing by changing only text and an image of the contents without changing the arrangement (layout) of objects. Examples of this include a monthly credit card billing statement sent to a user.

### (System Configuration)

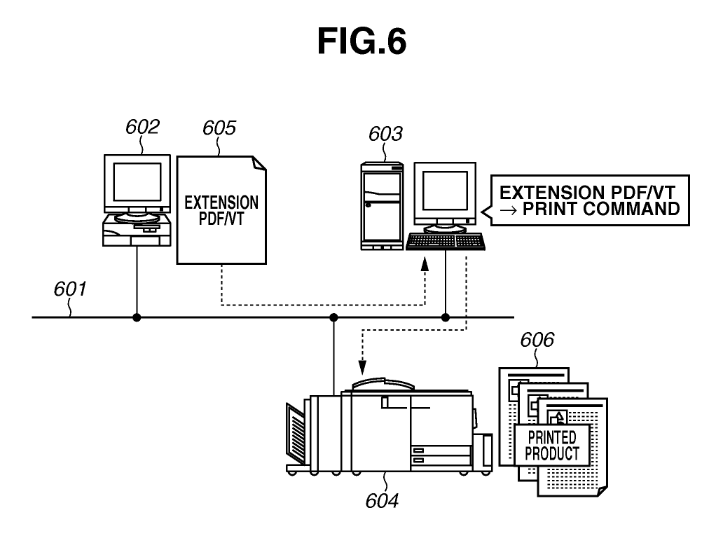

Using the extension PDF/VT described above, a description is given of a system for performing processes from the generation of print data to the printing of the print data. FIG. 6 is a schematic diagram illustrating an example of a configuration of a system and a flow of data. In this example, a client personal computer (PC) 602, a print server 603, and a printer 604, which are connected to a network 601, are provided.

The client PC (information processing apparatus) 602 generates extension PDF/VT 605 using an application for generating extension PDF/VT and transmits the generated extension PDF/VT 605 to the print server 603.

The print server (information processing apparatus) 603 analyzes the extension PDF/VT 605 received from the client PC 602, generates a print command for performing printing in the printer 604, and transmits the generated print command to the printer 604. The client PC 602 and the print server 603 may be included in the same information processing apparatus.

The printer (image forming apparatus) 604 performs printing according to the print command received from the print server 603 and outputs a printed product 606.

According to the present exemplary embodiment, processes related to extension PDF/VT are a process of generating extension PDF/VT, which is performed by the client PC 602, and a process of analyzing extension PDF/VT, which is performed by the print server 603. According to a first exemplary embodiment, a description is given of an application for performing the process of generating extension PDF/VT, which is performed by the client PC 602. An application for performing the process of analyzing extension PDF/VT, which is performed by the print server 603, will be described in a second exemplary embodiment. Hereinafter, each of the application for generating extension PDF/VT and the application for analyzing extension PDF/VT is occasionally referred to simply as an “application”.

### (Hardware Configuration)

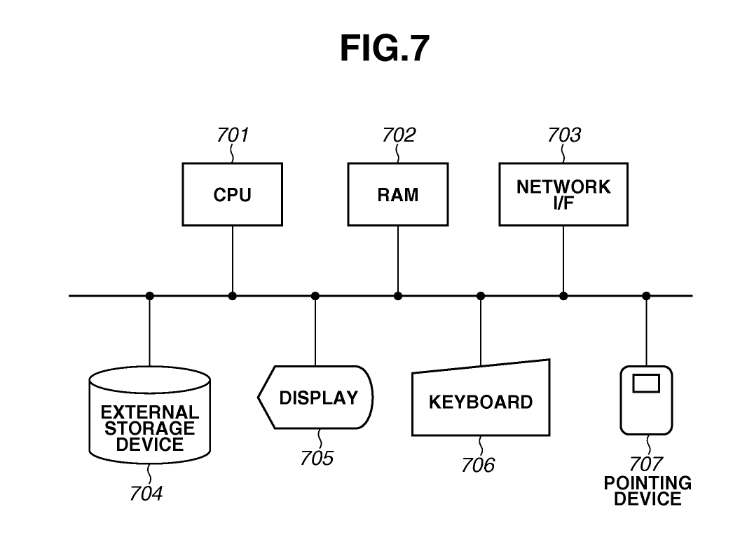

FIG. 7 is a diagram illustrating an example of each of the hardware configurations of the client PC 602 and the print server 603. According to the present exemplary embodiment, the hardware configurations of the client PC 602 and the print server 603 are similar to each other, and the following description is given using the hardware configuration of the client PC 602 as an example.

A central processing unit (CPU) 701 controls the entirety of the client PC 602. The CPU 701 loads a program stored in an external storage device 704 into a random-access memory (RAM) 702 and executes the program, thereby achieving the function of the client PC 602 and the processing of flow charts of the client PC 602 described below.

The RAM 702 is a storage area where a program to be executed by the CPU 701 and data, such as a document image, are temporarily stored.

A network interface (I/F) 703 is a network interface for connecting to a network under the control of the CPU 701, and transmits and receives data.

The external storage device 704 is a storage area, such as a magnetic disk, where various programs and data are saved.

Further, the client PC 602 includes a display 705, a keyboard 706, and a pointing device 707, such as a mouse. The display 705 may be configured to double as an operation unit for receiving an input instruction by using a touch operation of the user as in a touch panel.

A description is given of how an application of the client PC 602 operates according to the hardware configuration illustrated in FIG. 7.

As described above, the CPU 701 loads a program for an application stored in the external storage device 704 into the RAM 702 and executes the program, thereby achieving the function of the application. Further, the CPU 701 loads a program for an operating system (OS) stored in the external storage device 704 or the like into the RAM 702 and executes the program, thereby achieving the function of the OS. The application uses the function of the OS as needed when performing various types of processing.

Further, the application reads and writes content of internal data to be temporarily stored in the RAM 702, and reads and writes data from and to the external storage device 704. Further, if data is present on another computer, the application transmits and receives data to and from the computer via the network I/F 703 as needed. Furthermore, the application displays visual information, such as a user interface (hereinafter referred to as a “UI”), a processing result, or the like on the display 705 and receives an input from the user by using the keyboard 706 or the pointing device 707. In the following description of the operation of the application, the operations of the individual devices described above are not described.

As described above, the hardware configuration of the print server 603 is similar to that of the client PC 602. That is, a CPU 701 of the print server 603 loads a program stored in an external storage device 704 or the like of the print server 603 into a RAM 702 of the print server 603 and executes the program, thereby achieving the function of the print server 603 and the processing of flow charts of the print server 603 described below.

### (Operation of Application for Generating Extension PDF/VT)

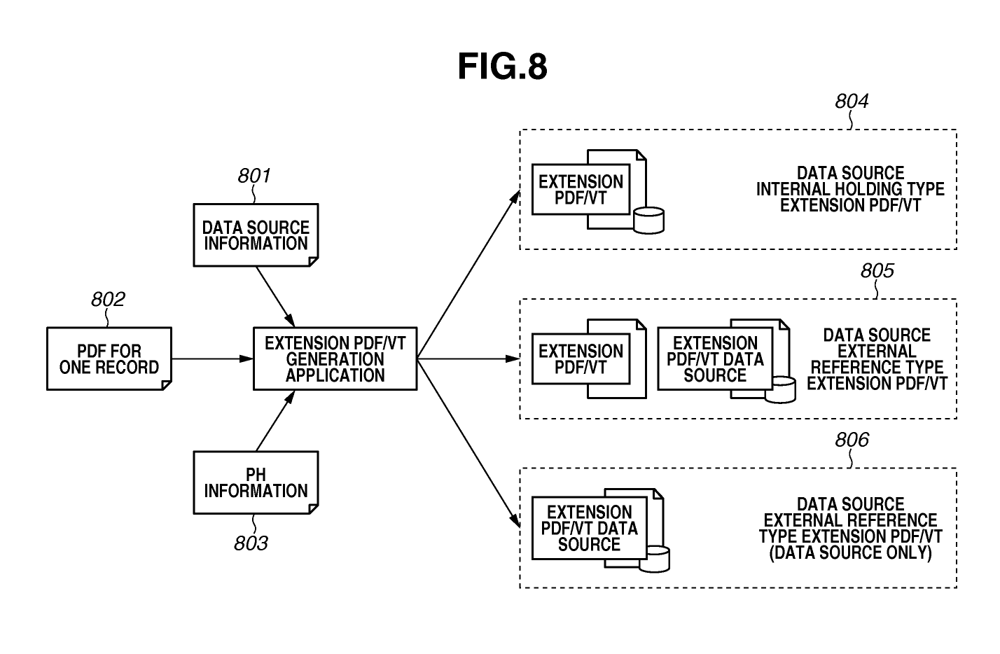

FIG. 8 is a diagram illustrating an example of an outline of processing of the application for generating extension PDF/VT in the client PC 602 (hereinafter referred to as “the application” according to the first exemplary embodiment).

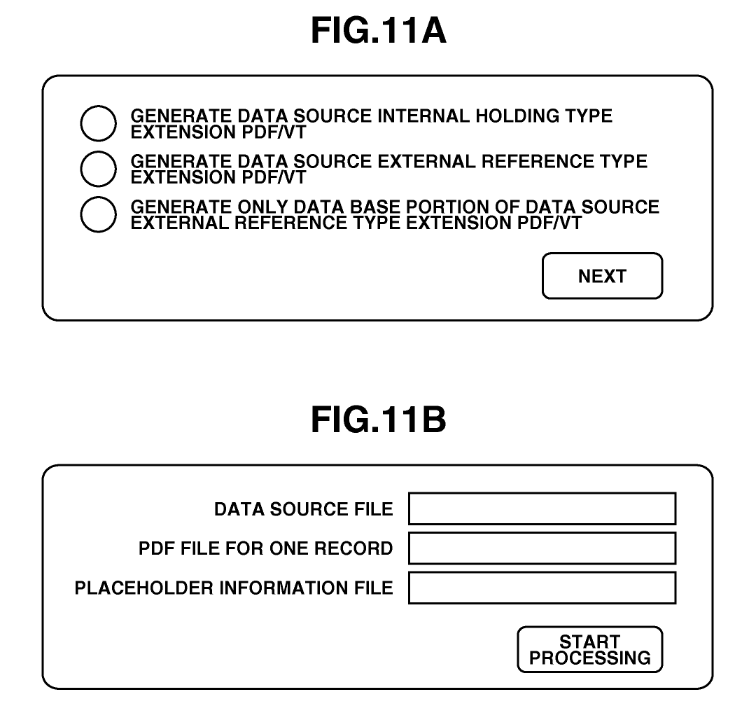

The application receives, from the user via a UI, an input for specifying any one or more of a data source information file 801, a PDF file 802 having Page objects for one record, and a placeholder information file 803. More specifically, to generate extension PDF/VT, the application receives an input for specifying the files 801, 802, and 803, from which to generate the extension PDF/VT, from the user via a UI (an instruction screen) described below with reference to FIG. 11B. The files 801, 802, and 803 may be stored in the external storage device 704 of the client PC 602 or may be stored in a storage device on the network 601. That is, the application obtains the files 801, 802, and 803 specified via the UI from the external storage device 704 or from the storage device on the network 601.

The application outputs any one of data source internal holding type extension PDF/VT 804, a set 805 of data source external reference type extension PDF/VT on the main body side and data source external reference type extension PDF/VT on the data side, or only data source external reference type extension PDF/VT 806 on the data side.

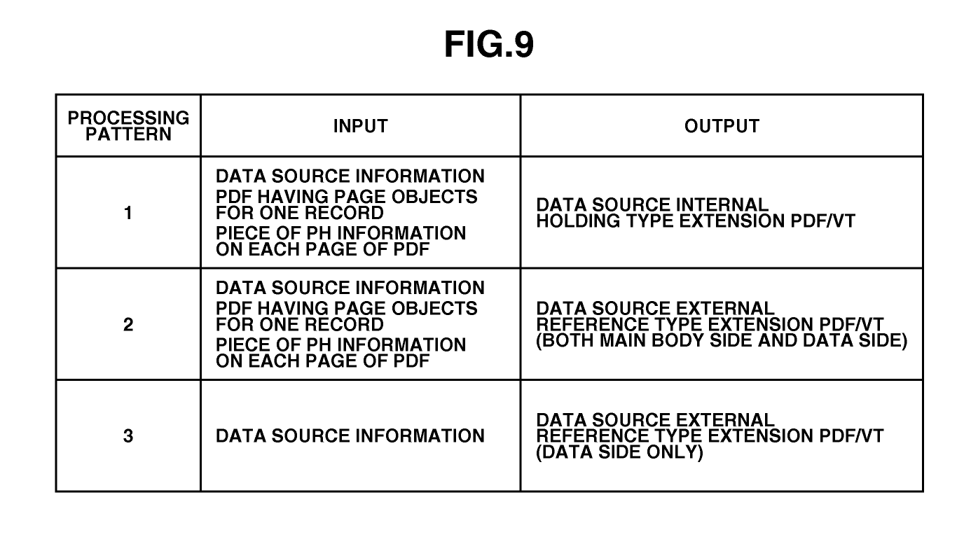

The details of the above processing will be described below with reference to FIG. 9 and the like.

FIG. 9 is a diagram illustrating an example of relationship between input data and output data in the application.

The application selects between three processing patterns depending on the type of the extension PDF/VT (804, 805, or 806) to be output.

In a “processing pattern 1”, the application inputs the data source information file 801, the PDF file 802 having Page objects for one record, and the placeholder information file 803 and outputs the data source internal holding type extension PDF/VT 804.
In a “processing pattern 2”, the application inputs the data source information file 801, the PDF file 802 having Page objects for one record, and the placeholder information file 803 and outputs the data source external reference type extension PDF/VT 805. The data source external reference type extension PDF/VT to be output by the application in the “processing pattern 2” is a set of the main body side and the data side.
In a “processing pattern 3”, the application inputs the data source information file 801 and outputs the data source external reference type extension PDF/VT 806 only on the data side. The application determines a processing pattern in which to perform processing, based on the selection made by the user and received via a UI described below with reference to FIG. 11A.

As described above, the advantage of the data source internal holding type extension PDF/VT is that this type facilitates the management of a file. The advantage of the data source external reference type extension PDF/VT is that it is possible to easily print different contents in the same layout only by replacing data side files. Thus, in a case where the user wishes to reduce the load of management, the user may select the “processing pattern 1”. In a case where the user wishes to print different contents in the same layout multiple times, the user may select the “processing pattern 2” and the “processing pattern 3”. Thus, it is possible to improve the convenience of the user in variable-data printing.

In a case where the application outputs the data source external reference type extension PDF/VT 805, the application, according to an instruction from the user, performs processing in the “processing pattern 2” at the first time to output both a main body side file and a data side file. Then, the application transmits both the main body side file and the data side file to the print server 603 and causes the print server 603 to start processing. Then, from the second time onward, the application performs processing in the “processing pattern 3” to output only a data side file. Then, the application transmits the data side file to the print server 603 and causes the print server 603 to start processing. Thus, the application can perform printing.

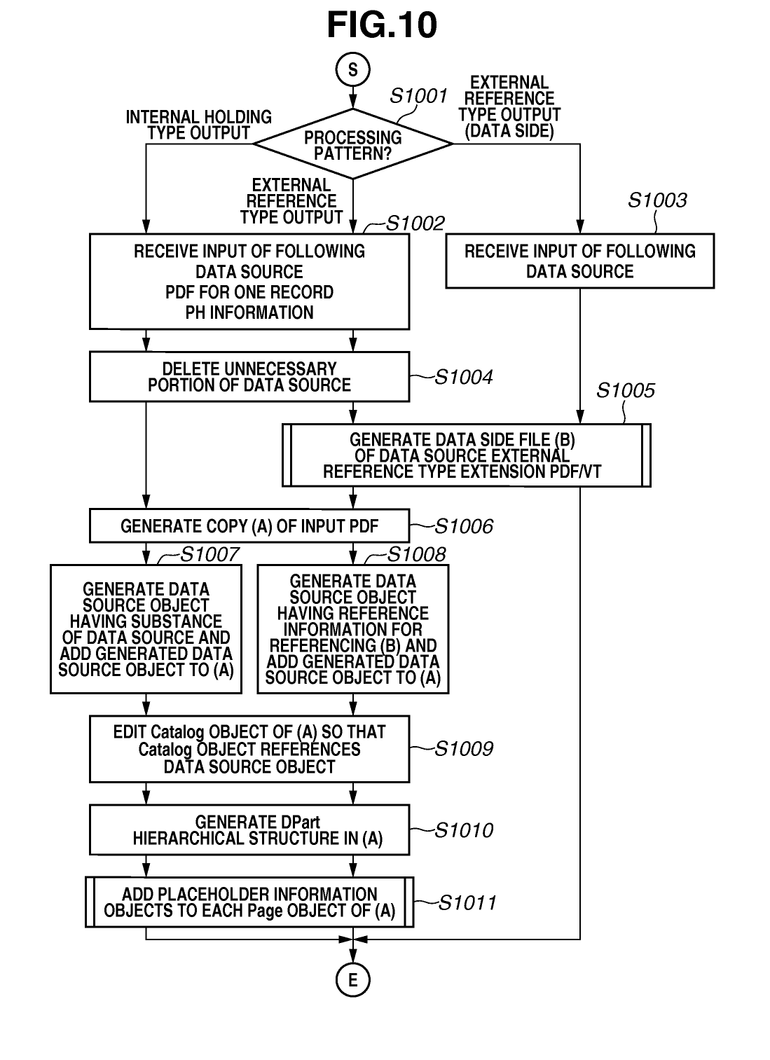

With reference to a flow chart in FIG. 10, the flow of the processing of the application is described. FIG. 10 is a flow chart illustrating an example of processing performed by the client PC 602 according to the present exemplary embodiment.

In step S1001, the application displays a UI illustrated in FIG. 11A and receives from the user the selection of a processing pattern. FIG. 11A is a diagram illustrating an example of the UI displayed by the application at this time. The UI illustrated in FIG. 11A receives from the user an instruction to select whether to generate data source internal holding type PDF/VT, or generate a set of data source external reference type PDF/VT on the main body side and data source external reference type PDF/VT on the data side, or only generate data source external reference type PDF/VT on the data side. Hereinafter, the process of the application generating data source internal holding type PDF/VT is referred to as the “processing pattern 1”. The process of the application generating a set of data source external reference type PDF/VT on the main body side and data source external reference type PDF/VT on the data side is referred to as the “processing pattern 2”. Further, the process of the application only generating data source external reference type PDF/VT on the data side is referred to as the “processing pattern 3”. According to the instruction received from the user via the UI illustrated in FIG. 11A, the application determines, from among the above processing patterns illustrated in FIG. 9, a processing pattern in which to perform processing.

In step S1002 or S1003, the application receives an input according to corresponding processing pattern from the user via a UI. FIG. 11B is a diagram illustrating an example of the UI displayed by the application at this time. In the case of the “processing pattern 1” or the “processing pattern 2”, in step S1002, the application receives, from the user via the UI, an input for specifying the data source information file 801, the PDF file 802 having Page objects for one record, and the placeholder information file 803. On the other hand, in the case of the “processing pattern 3”, in step S1003, the application receives, from the user via the UI, an input for specifying the data source information file 801.

The data source information file 801 has data that serves as a data source portion of the extension PDF/VT to be generated by the application. The format of the data source information file 801 may be any format capable of representing a general data source, such as CSV or Extensible Markup Language (XML).

The PDF file 802 having Page objects for one record is a normal PDF file. A group of pages included in this PDF file is handled as a group of pages for one record.

The placeholder information file 803 is a file having placeholder information to be added to each page of the PDF file 802 having Page objects for one record.

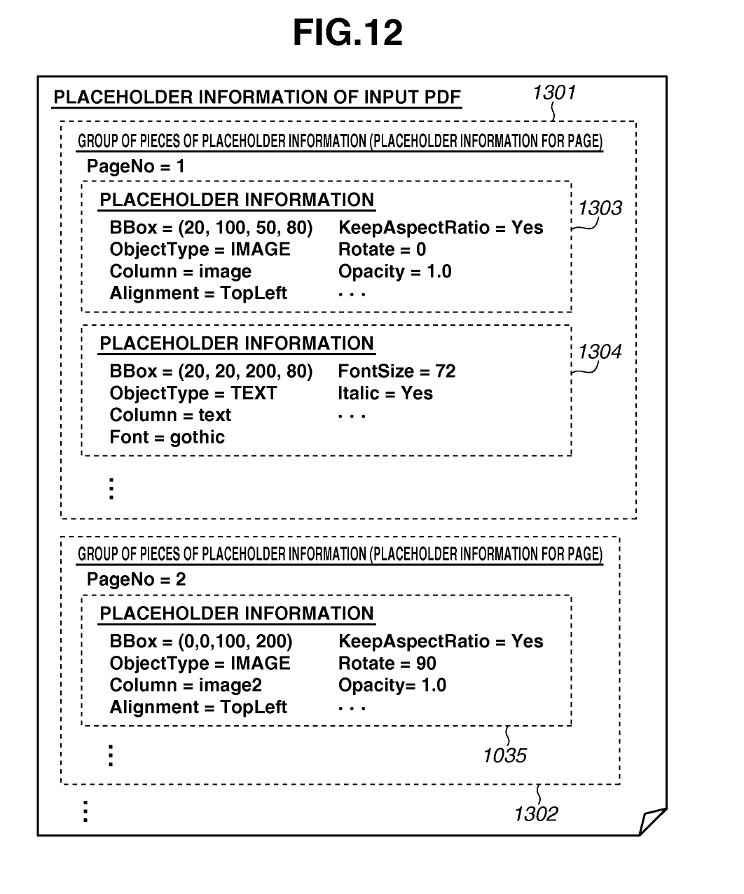

FIG. 12 is a diagram illustrating an example of the placeholder information file 803.

The placeholder information file 803 has groups of pieces of placeholder information (1301 and 1302) for arbitrary number of pages. The number of groups of pieces of placeholder information (1301 and 1302) of the placeholder information file 803 needs to be the same as the number of pages of the PDF file 802. The groups of pieces of placeholder information (1301 and 1302) have as many pieces of placeholder information (1303, 1304, and 1305) to be added to corresponding pages as the user wishes to add.

The pieces of placeholder information (1303, 1304, and 1305) have pieces of attribute information of corresponding placeholders and pieces of information for instantiation. For example, the placeholder information 1305 illustrated in FIG. 12 has the following information.
The drawing area (BBox) has a size (BBox=(0,0,100,200)) from the position of coordinates (0, 0) to the position of coordinates (100, 200).
The type of the drawing object (ObjectType) is an “image” (ObjectType=IMAGE).
Obtains the file name of the image from an “image2” column of the data source (Column=image2).
The drawing position in the drawing area (Alignment) is set based on the top left corner (Alignment=TopLeft).
Holds the aspect ratio of the image (KeepAspectRatio=Yes).
Rotates 90 degrees (Rotate=90).
The opacity is 1.0 (Opacity=1.0).

The format of the placeholder information file 803 may be any format, such as the initialization file (INI) format or the XML format, which is generally used as a setting file, so long as the format can represent the above information.

The description returns to FIG. 10.

In the case of the processing pattern 1 or the processing pattern 2, in step S1004, the application deletes an unnecessary portion of the data source. The data source file specified by the user via the UI may have a portion that is not used, that is, a column that is not referenced when any of the placeholders is instantiated. It is a waste to leave this column because the column only increases the data size of the extension PDF/VT to be output by the application. Thus, the application deletes the unnecessary portion at this stage. The application analyzes the placeholder information file 803 specified by the user via the UI and determines whether each column is not referenced, based on whether the column is not referenced by any of the placeholders. More specifically, in all the pieces of placeholder information (1303, 1304, and 1305), the application determines a column that does not appear in any reference destination column name (the value of each “Column” property in FIG. 12), as a column that is not referenced by any of the placeholders. This enables the application to reduce the data size of the PDF/VT to be output.

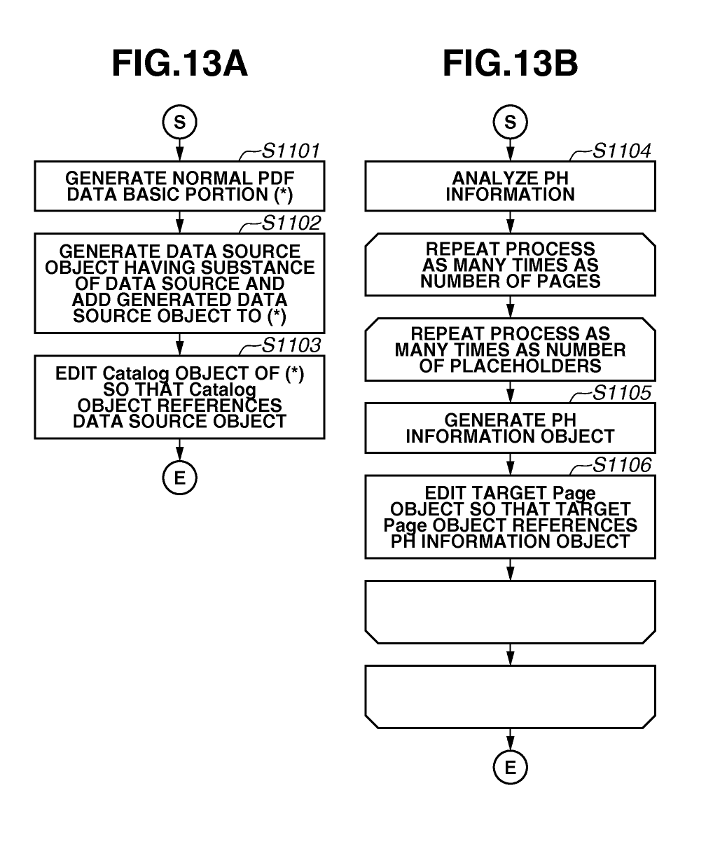

In step S1005, in the case of the processing pattern 2 or the processing pattern 3, the application generates a data side file of the data source external reference type extension PDF/VT. This process will be described in detail later with reference to FIG. 13A.

In step S1006, in the case of the processing pattern 1 or the processing pattern 2, the application generates a copy of the PDF file 802 having Page objects for one record specified by the user in step S1002. Hereinafter, in the processing of this flow chart, a copy of the PDF file 802 having Page objects for one record is referred to as (A).

In step S1007, in the case of the processing pattern 1, the application generates a data source object having the substance of the data source based on the data source information file 801 specified by the user in step S1002 and adds the generated data source object to (A) generated in step S1006. This process corresponds to generating the DataSource object 302 illustrated in FIG. 3A, which is a schematic diagram illustrating the internal structure of the data source internal holding type extension PDF/VT. Further, this process also corresponds to generating the DataSource object 403 illustrated in FIG. 4, which illustrates the example of the scripts of the data source internal holding type extension PDF/VT. For example, if the data source information file 801 specified by the user via the UI has the contents illustrated in FIG. 1B, the application generates, from column names 109 and the pieces of record data 105, 106, 107, and 108, the DataSource object 403, which has a data portion represented by the description 404 illustrated in FIG. 4. More specifically, the data source 110 illustrated in FIG. 1B has columns having the names “id”, “image”, and “text”. Thus, the application describes a column name portion of the DataSource object 403 as “/ColumnName[(id)(image)(text)]”. Further, the data source 110 illustrated in FIG. 1B has the four pieces of record data 105, 106, 107, and 108. Thus, the application describes the contents of the four pieces of record data 105, 106, 107, and 108 using a two-dimensional array in a portion starting with “/Data”.

In step S1008, in the case of the processing pattern 2, the application generates a DataSource object having reference information for referencing the data side file of the data source external reference type extension PDF/VT generated in step S1005 and adds the generated DataSource object to (A) generated in step S1006. This process corresponds to generating the DataSource object 309 illustrated in FIG. 3B, which is a schematic diagram illustrating the internal structure of the data source external reference type extension PDF/VT. Further, this process also corresponds to generating the DataSource object 502 illustrated in FIG. 5A, which illustrates examples of the scripts of the data source external reference type extension PDF/VT. The application describes the name of the data side file of the data source external reference type extension PDF/VT generated in step S1005, in a portion following “/F” in the reference information 503, which is included in the DataSource object 502 and related to a reference to an external file.

In step S1009, in the case of the processing pattern 1 or the processing pattern 2, the application edits a Catalog object of (A) so that the Catalog object references the data source object generated in step S1007 or S1008.

In the processing pattern 1, this process corresponds to describing reference information for referencing the DataSource object 302, in the Catalog object 301, which is illustrated in FIG. 3A, which is a schematic diagram illustrating the internal structure of the data source internal holding type extension PDF/VT. Further, this process also corresponds to describing a script that means a reference to the DataSource object 403, in the Catalog object 401, which is illustrated in FIG. 4, which illustrates examples of the scripts of the data source internal holding type extension PDF/VT. The script that means a reference to the DataSource object 403 is the “/DataSource20R” portion (the reference information 402).

In the case of the processing pattern 2, this process corresponds to describing reference information for referencing the generated DataSource object 309, in the Catalog object 313, which is illustrated in FIG. 3B, which is a schematic diagram illustrating the internal structure of the data source external reference type extension PDF/VT. Further, this process also corresponds to describing a script that means a reference to the DataSource object 502, in a Catalog object 512, which is illustrated in FIG. 5A, which illustrates the example of the scripts of the data source external reference type extension PDF/VT. The script that means a reference to the DataSource object 502 is a “/DataSource20R” portion (reference information 513).

In step S1010, in the case of the processing pattern 1 or the processing pattern 2, the application generates a DPart hierarchical structure in (A). More specifically, this process corresponds to generating a group of objects in a DPart hierarchical structure portion as illustrated in FIGS. 3A and 3B.

In step S1011, in the case of the processing pattern 1 or the processing pattern 2, the application adds placeholder information objects to each Page object of (A). This process will be described in detail later with reference to FIG. 13B.

FIG. 13A is a flow chart illustrating an example of the process of step S1005.

In step S1101, the application generates a normal PDF data basic portion. The “normal PDF data basic portion” here refers to a portion other than page information, such as Page objects and the like, and includes the Catalog object 311. Although the normal PDF data basic portion also includes an object other than the Catalog object 311, the generation of this portion can be achieved by a known technique, and therefore is not described in detail here. The application generates the Catalog object 311 illustrated in FIG. 3B as a component related to the present exemplary embodiment.

In step S1102, the application generates a data source object having the substance of the data source based on the data source information file 801 specified by the user in step S1002 and adds the generated data source object to the PDF data basic portion generated in step S1101. This process corresponds to generating the DataSource object 312, which is illustrated in FIG. 3B, which is a schematic diagram illustrating the internal structure of the data source external reference type extension PDF/VT. Further, this process also corresponds to generating the DataSource object 507, which is illustrated in FIG. 5B, which illustrates the example of the scripts of the data source external reference type extension PDF/VT. The specific method for generating the DataSource object 507 in FIG. 5B is similar to the method in step S1007.

In step S1103, the application edits a Catalog object of the data generated in step S1101 so that the Catalog object references the data source object generated in step S1102. This process corresponds to describing reference information for referencing the generated DataSource object 312, in the Catalog object 311, which is illustrated in FIG. 3B, which is a schematic diagram illustrating the internal structure of the data source external reference type extension PDF/VT. Further, this process also corresponds to describing a script that means a reference to the DataSource object 507, in the Catalog object 505, which is illustrated in FIG. 5B, which illustrates examples of the scripts of the data source external reference type extension PDF/VT. The script that means a reference to the DataSource object 507 is the “/DataSource20R” portion (the reference information 506).

FIG. 13B is a flow chart illustrating an example of a process of step S1011.

In step S1104, the application analyzes the placeholder information file 803 specified by the user in step S1002 and obtains the number of pieces of placeholder information (1301 and 1302) for the respective pages and the number of pieces of placeholder information (1303, 1304, and 1305) on each page.

Then, the application repeats the processes of steps S1105 and S1106 as many times as the number of pieces of placeholder information (1301 and 1302) for the respective pages. Further, in the pieces of placeholder information (1301 and 1302), the application repeats the processes of steps S1105 and S1106 as many times as the number of pieces of placeholder information (1303, 1304, and 1305) on each page.

In step S1105, the application generates placeholder information objects based on the contents of the pieces of placeholder information (1303, 1304, and 1305) of the placeholder information file 803 specified by the user in step S1002. In the case of the processing pattern 1, this process corresponds to generating the PHInfo objects 308 illustrated in FIG. 3A. In the example of the scripts illustrated in FIG. 4, this process corresponds to generating the PHInfo objects 407 and 408. Further, in the case of the processing pattern 2, this process corresponds to generating the PHInfo objects 315 illustrated in FIG. 3B. In the examples of the scripts illustrated in FIG. 5A, this process corresponds to generating a PHInfo object 509. For example, in a case where the placeholder information 1303 is a target, the application generates the script of the PHInfo object 407, which is, more specifically, BBox=(20,100,50,80) in the placeholder information 1303. Thus, the application describes “/BBox[20,100,50,80]” in the PHInfo object 407. The same goes for the other pieces of attribute information.

In step S1106, the application edits a target Page object so that the target Page object references the placeholder information objects generated in step S1105. In the case of the processing pattern 1, this process corresponds to describing, in one of the Page objects 307 illustrated in FIG. 3A, reference information for referencing the PHInfo objects 308 generated in step S1105. In the example of the scripts illustrated in FIG. 4, this process corresponds to describing in the Page object 405 the reference information 406 for referencing the PHInfo objects 407 and 408 generated in step S1105. Further, in the case of the processing pattern 2, this process corresponds to describing, in one of the Page objects 314 illustrated in FIG. 3B, reference information for referencing the PHInfo objects 315 generated in step S1105. In the example of the scripts illustrated in FIG. 5A, this process corresponds to describing, in a Page object 510, reference information 511 for referencing the PHInfo object 509 generated in step S1105.

In the above description, the application varies a processing pattern in step S1001 in FIG. 10, thereby three different types of processing is enabled in a single application. Alternatively, the client PC 602 may be configured to have three independent applications for performing the processes in the three respective patterns after step S1001. This is because, even in a form in which the client PC 602 has independent applications as described above, the client PC 602 can output extension PDF/VT. Thus, the effect of extension PDF/VT in reducing the amount of data as compared to normal PDF/VT is not lost.

Further, the above description has been given on the assumption that the application receives, from the user via the UI, an input for specifying the files 801, 802, and 803 and outputs extension PDF/VT based on the files 801, 802, and 803 obtained according to the specifying. Alternatively, an exemplary embodiment is also possible in which the application does not obtain, as a file, data for outputting extension PDF/VT. For example, the application displays a UI for receiving an input for editing a layout of a template and generating placeholder information and a data source. Then, the user inputs information about the editing of the layout of the template, a placeholder, or a data source via the displayed UI. This enables the application to generate the files 801, 802, and 803 based on the information input by the user via the UI. That is, the client PC 602 itself can generate the files 801, 802, and 803 and output extension PDF/VT.

As described above, according to the present exemplary embodiment, the client PC 602 can generate and output extension PDF/VT capable of reducing the amount of print data even with a large number of records, in variable-data printing.

### (Operation of Application for Analyzing Extension PDF/VT)

In a second exemplary embodiment, a description is given of an application for performing a process of analyzing extension PDF/VT in the print server 603.

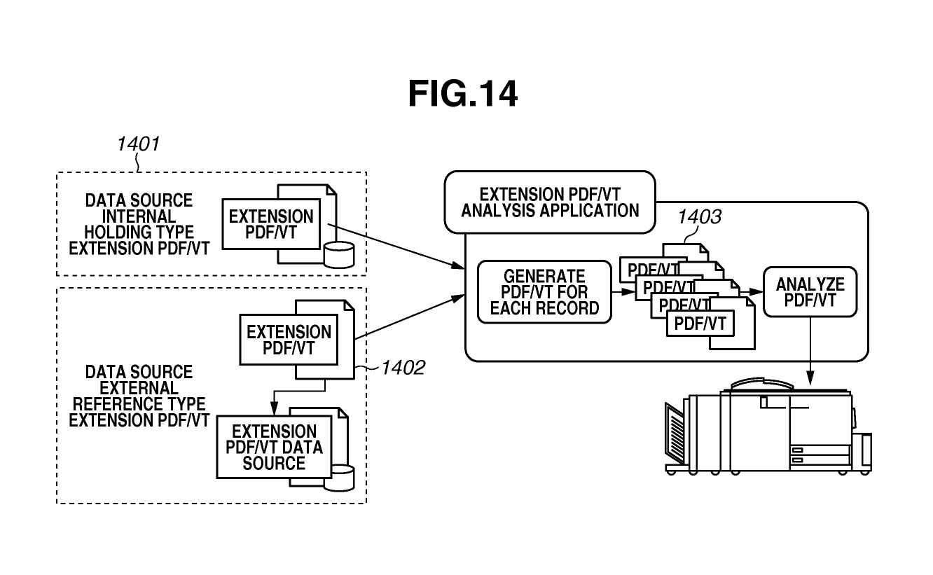

FIG. 14 is a diagram illustrating an example of an outline of processing of an application for analyzing extension PDF/VT in the print server 603 (hereinafter referred to as “the application” in the second exemplary embodiment).

The application receives, as an input, data source internal holding type extension PDF/VT 1401 or data source external reference type extension PDF/VT 1402 on the main body side. Then, the application instantiates the extension PDF/VT, generates PDF/VT 1403 for each record, further analyzes the generated PDF/VT 1403, generates a print command, and transmits the print command to the printer 604.

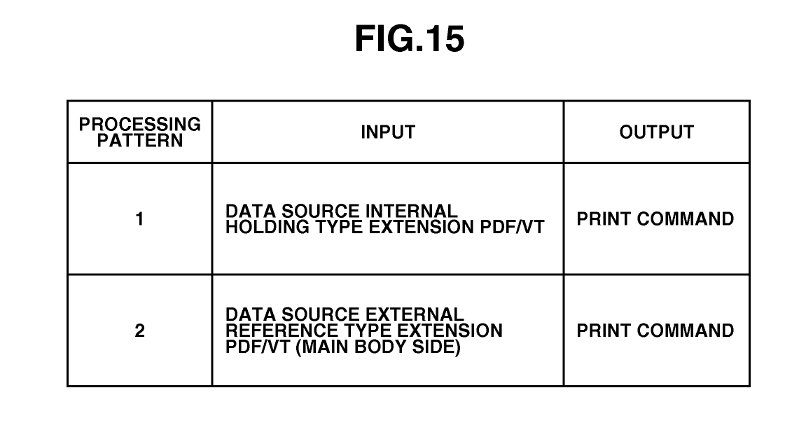

FIG. 15 is a diagram illustrating an example of relationship between input data and output data in the application.

The application selects between two processing patterns depending on the type of the input extension PDF/VT (1401 or 1402) received from the user.

In a “processing pattern 1”, the application inputs the data source internal holding type extension PDF/VT 1401 and outputs a print command.
In a “processing pattern 2”, the application inputs the data source external reference type extension PDF/VT 1402 on the main body side and outputs a print command.

The application determines either of the processing patterns by analyzing input extension PDF/VT received from the user and identifying whether the input extension PDF/VT is the data source internal holding type extension PDF/VT 1401 or the data source external reference type extension PDF/VT 1402.

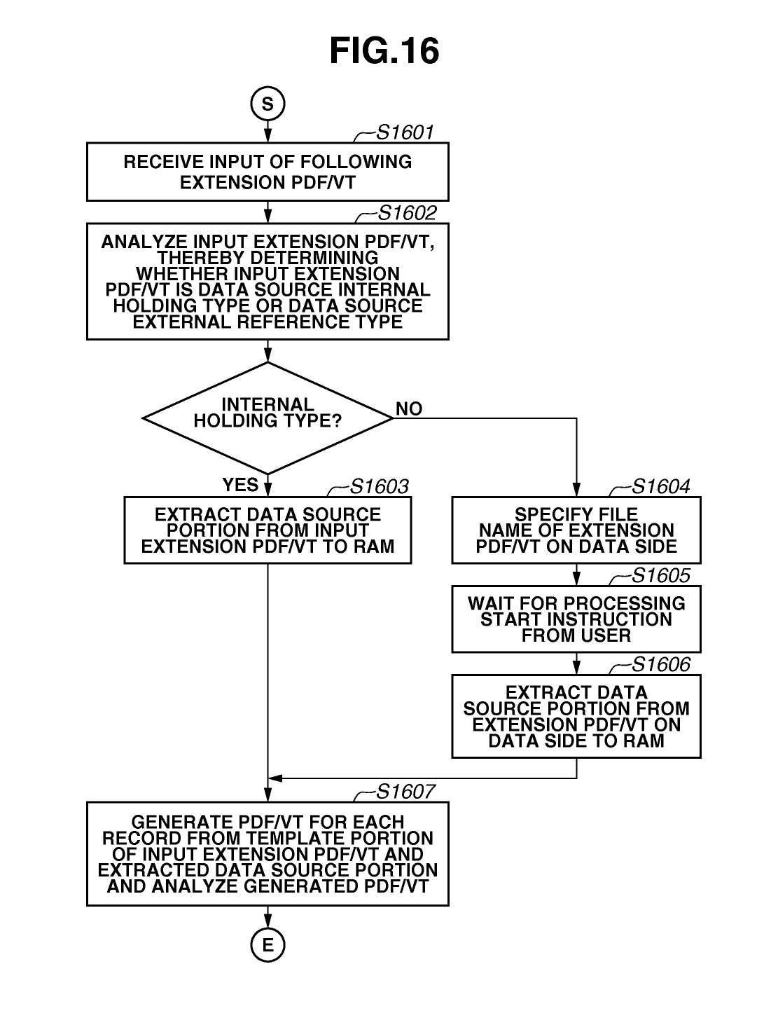

With reference to a flow chart in FIG. 16, the flow of processing of the application is described. FIG. 16 is a flow chart illustrating an example of processing performed by the print server 603 according to the present exemplary embodiment.

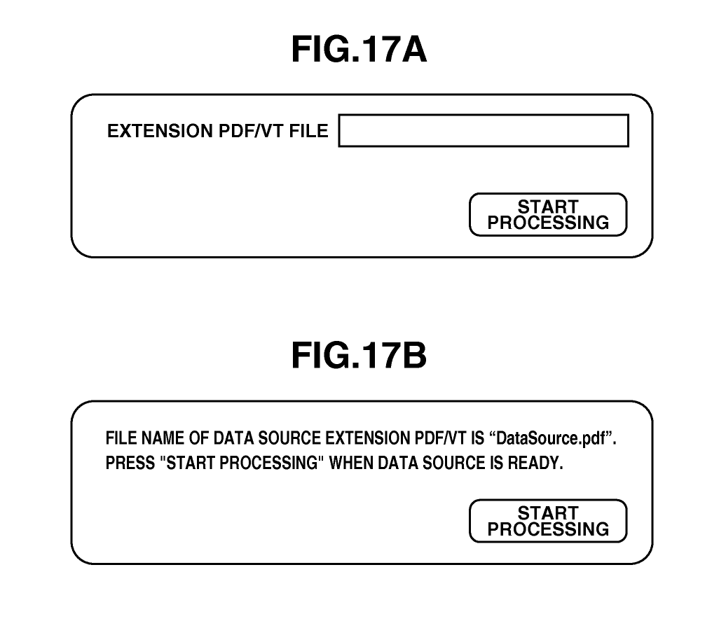

In step S1601, the application displays a UI illustrated in FIG. 17A and receives from the user an input for specifying the extension PDF/VT 1401 or 1402. FIG. 17A is a diagram illustrating an example of the UI displayed by the application at this time. The application can receive, from the user via the UI illustrated in FIG. 17A, an input for specifying an extension PDF/VT file.

In step S1602, the application analyzes the extension PDF/VT specified by the user in step S1601, thereby determining whether the specified extension PDF/VT is the data source internal holding type extension PDF/VT 1401 or the data source external reference type extension PDF/VT 1402. The application performs the determination in step S1602 by analyzing the DataSource object of the extension PDF/VT and examining whether the substance of the data source is present and whether reference information for referencing an external file is described. More specifically, in the case of FIG. 3A, which is a schematic diagram illustrating the internal structure of the extension PDF/VT, this process corresponds to the application analyzing the DataSource object 302 and examining whether the substance 303 of the data source is present. Further, in the case of FIG. 3B, this process corresponds to the application analyzing the DataSource object 309 and examining whether reference information for referencing the data side file 310, which is an external file, is present. Further, in FIG. 4, which illustrates the example of the scripts, this process corresponds to the application analyzing the DataSource object 403 and examining whether the substance portion of the data source, namely the description 404, is present. Further, in FIG. 5A, which illustrates the example of the scripts, this process corresponds to t the application analyzing the DataSource object 502 and examining whether the reference information 503 for referencing an external file is present.

The description returns to FIG. 16.

As a result of the determination in step S1602, in a case where the specified extension PDF/VT is the data source internal holding type extension PDF/VT 1401, the application performs the process of step S1603. In a case where the specified extension PDF/VT is the data source external reference type extension PDF/VT 1402, the application performs the processes of steps S1604, S1605, and S1606.

In step S1603, the application extracts the substance portion of the data source from the extension PDF/VT 1401 to the RAM 702. In the example of the scripts in FIG. 4, this process corresponds to extracting the substance portion (the description 404) of the data from the DataSource object 403 and saving the extracted substance portion as internal data in the RAM 702.

In the case of the data source external reference type extension PDF/VT 1402, in step S1604, the application specifies the file name of data source external reference type extension PDF/VT on the data side. In the example of the scripts in FIG. 5A, this process corresponds to obtaining, from the reference information 503 of the DataSource object 502 of the main body side file, the file name referenced by the DataSource object 502.

In step S1605, the application displays a UI and waits for a processing start instruction from the user. The process of step S1605, however, is not essential. This process is performed so that the user prepares data source external reference type extension PDF/VT on the data side. However, for example, in the case of a processing flow on the premise that the user prepares a data side file in advance in the process of step S1601, the process of step S1605 is unnecessary.

FIG. 17B is a diagram illustrating an example of the UI displayed in step S1605. The UI in FIG. 17B can indicate the file name of the data source external reference type extension PDF/VT on the data side to the user, and after the user has prepared the file, can receive a processing start instruction from the user. After the UI illustrated in FIG. 17B has been displayed and in a case where the user wishes to replace the data source, the user may prepare new data source external reference type extension PDF/VT on the data side and instruct the application to start processing, using the UI illustrated in FIG. 17B.

The description returns to FIG. 16.

In the case of the data source external reference type extension PDF/VT 1402, in step S1606 after step S1605, the application extracts the substance portion of the data source from the data source external reference type extension PDF/VT on the data side to the RAM 702. In the example of the scripts illustrated in FIG. 5B, this process corresponds to extracting the substance portion (the description 508) of the data from the DataSource object 507 of the data side file and saving the extracted substance portion as internal data in the RAM 702.

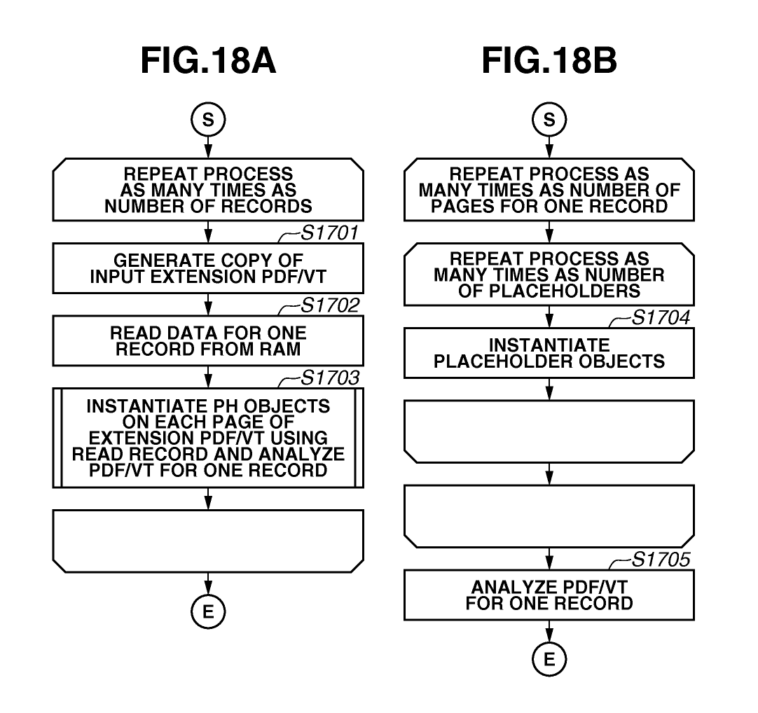

In step S1607, the application generates PDF/VT for each record from the template portion of the extension PDF/VT specified by the user in step S1601 and the data source portion extracted to the RAM 702 and analyzes the generated PDF/VT. The process of step S1607 will be described in detail later with reference to FIG. 18A.

FIG. 18A is a flow chart illustrating an example of the process of step S1607.

In step S1701, the application generates a copy of the extension PDF/VT specified by the user in step S1601. In the case of the data source internal holding type PDF/VT 1401, this corresponds to the application generating data having the same structure as that illustrated in FIG. 3A, as internal data in the RAM 702. Further, in the case of the data source external reference type PDF/VT 1402, this corresponds to the application generating data having the same structure as that of the main body side 316 illustrated in FIG. 3B, as internal data in the RAM 702.

In step S1702, the application reads data for one record from the data source extracted to the RAM 702 in step S1603 or S1606. For example, in the example of the scripts illustrated in FIG. 4, this corresponds to the application reading a data array for one line from the data source portion (the description 404) extracted to the RAM 702. The “data array for one line” refers to, for example, in the first record, an array of which elements are three pieces of text “001”, “a.jpeg”, and “aaa”.

In step S1703, the application instantiates placeholder objects on each page of the copy of the extension PDF/VT generated in step S1701, using the record data read in step S1702, to generate PDF/VT for one record, and then analyzes the generated PDF/VT. The process of step S1703 will be described in detail later with reference to FIG. 18B.

The application repeats the processes of steps S1701 to S1703 as many times as the number of records of the data source extracted to the RAM 702.

FIG. 18B is a flow chart illustrating an example of a process of step S1703.

In step S1704, the application instantiates placeholder objects for the respective pages for one record and further instantiates each placeholder object on each page, using the record data of the record. More specifically, the application reads information for instantiation described in each placeholder object and replaces the placeholder object with a normal drawing object according to the read information, thereby instantiating the placeholder object. The information for instantiation described in each placeholder object is, specifically, the type of the object, such as an image or text, and the target column of the data source. For example, in the PHInfo object 407 in the example of the scripts in FIG. 4, the object type is an image (“/ObjectType/IMAGE”), and the target column of the data source is an “image” (“/Column(image)”). Then, the application reads the “image” column of the data source based on this information. In the case of the first record, the application replaces the PHInfo object 407 with an image described in a file having the name “a.jpeg”, as a drawing object. When the application has instantiated all the placeholders for all the pages for one record, this results in PDF/VT for one record.

In step S1705, the application analyzes the resulting PDF/VT for one record and generates a print command. The process of analyzing PDF/VT for one record is a known technique, and therefore is not described here.

By the above processing, the print server 603 can generate PDF/VT for one record from extension PDF/VT. That is, the print server 603 can generate PDF/VT for each record and generate a print command. Then, the print server 603 transmits the generated print command to the printer 604 and thereby the printed product 606 can be generated.

In the above description, the application once generates PDF/VT for each record from extension PDF/VT and then analyzes the generated PDF/VT. Alternatively, the application can directly analyze the extension PDF/VT. In this case, immediately after instantiating placeholders in step S1704, the application may analyze instantiated drawing objects and sequentially output print commands, which are the analysis results.

Further, the application for analyzing extension PDF/VT may not only output a print command but also display an image of an analysis result on the display 705 or convert the extension PDF/VT into a different PDL.

Further, an exemplary embodiment is possible in which, in a case where the application receives the external reference type extension PDF/VT 1402 in the process of step S1601, the application receives not only the main body side but a set of the main body side and the data side, thereby omitting the process of step S1605.

As described above, according to the above exemplary embodiments, it is possible to reduce the amount of print data even with a large number of records in variable-data printing.

Embodiments of the present invention can also be realized by a computer of a system or apparatus that reads out and executes computer executable instructions recorded on a storage medium (e.g., non-transitory computer-readable storage medium) to perform the functions of one or more of the above-described embodiment(s) of the present invention, and by a method performed by the computer of the system or apparatus by, for example, reading out and executing the computer executable instructions from the storage medium to perform the functions of one or more of the above-described embodiment(s). The computer may comprise one or more of a central processing unit (CPU), micro processing unit (MPU), or other circuitry, and may include a network of separate computers or separate computer processors. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2014-075826 filed Apr. 1, 2014, which is hereby incorporated by reference herein in its entirety.

What is claimed is:

1. An information processing apparatus comprising:
a first generation unit configured to generate a data source object based on data source information;
a first description unit configured to describe, in variable print data in variable-data printing, reference information for referencing the data source object generated by the first generation unit;
a second generation unit configured to generate, based on placeholder information, a placeholder object related to generation of a print object based on the data source object to be referenced by the reference information described by the first description unit; and
a second description unit configured to describe, in a page object of the variable print data, reference information for referencing the placeholder object generated by the second generation unit,
wherein the first generation unit generates the data source object inside the variable print data.

2. The information processing apparatus according to claim 1, further comprising a first transmission unit configured to, in a case where the first generation unit has generated the data source object inside the variable print data, transmit the variable print data to a print server.

3. The information processing apparatus according to claim 1, wherein the first generation unit generates the data source object outside the variable print data.

4. The information processing apparatus according to claim 3, further comprising a second transmission unit configured to, in a case where the first generation unit has generated the data source object outside the variable print data, transmit the variable print data and another piece of variable print data including the generated data source object to a print server.

5. The information processing apparatus according to claim 1, further comprising a display unit configured to display an instruction screen related to generation of the variable print data,
wherein the first generation unit generates the data source object based on the data source information input via the instruction screen, and
wherein the second generation unit generates the placeholder object based on the placeholder information input via the instruction screen.

6. The information processing apparatus according to claim 1, wherein the variable print data is PDF/VT data including the page object in which a print object related to data for one record of the data source information is generated.

7. A method for an information processing apparatus, the method comprising:
generating, as first generating, a data source object based on data source information;
describing, as first describing, in variable print data in variable-data printing, reference information for referencing the generated data source object;
generating, as second generating, based on placeholder information, a placeholder object related to generation of a print object based on the data source object to be referenced by the described reference information; and
describing, as second describing, in a page object of the variable print data, reference information for referencing the generated placeholder object,
wherein in the first generating, the data source object is generated inside the variable print data.

8. A computer readable storage medium on which is stored a computer program for making a computer execute a method for an information processing apparatus, the method comprising:
generating, as first generating, a data source object based on data source information;
describing, as first describing, in variable print data in variable-data printing, reference information for referencing the generated data source object;
generating, as second generating, based on placeholder information, a placeholder object related to generation of a print object based on the data source object to be referenced by the described reference information; and
describing, as second describing, in a page object of the variable print data, reference information for referencing the generated placeholder object,
wherein in the first generating, the data source object is generated inside the variable print data.
